(19) United States
(12) Patent Application Publication
(10) Pub. No.: US 2019/0067729 A1
(43) Pub. Date: Feb. 28, 2019

(54) LITHIUM ION ELECTROCHEMICAL DEVICES HAVING EXCESS ELECTROLYTE CAPACITY TO IMPROVE LIFETIME

(71) Applicant: GM Global Technology Operations LLC, Detroit, MI (US)

(72) Inventors: Zhiqiang Yu, Pudong (CN); Meiyuan Wu, Pudong (CN); Xiaochao Que, Shanghai (CN); Fei Pan, Shanghai (CN); Sherman H. Zeng, Troy, MI (US)

(73) Assignee: GM Global Technology Operations LLC, Detroit, MI (US)

(21) Appl. No.: 15/689,059

(22) Filed: Aug. 29, 2017

(51) Int. Cl. H01M 10/052; H01M 2/02; H01M 4/62

(52) U.S. Cl. CPC H01M 10/052; H01M 2/263; H01M 4/623; H01M 2/0207

(57) ABSTRACT

The present disclosure provides an electrochemical device that may include a stack having at least one electrochemical cell having a first electrode, a second electrode, a porous separator, and an electrolyte liquid disposed in the porous separator and optionally disposed in the first electrode, the second electrode, or both the first electrode and the second electrode. The stack has a first volume of electrolyte liquid. The electrochemical device also has an integrated storage region that stores a second volume of electrolyte liquid and is in fluid communication with the plurality of electrochemical cells and is configured to transfer the electrolyte liquid into the plurality of electrochemical cells, wherein the second volume of electrolyte liquid is at least about 3% of the first volume. Methods of increasing lifetime of the electrochemical device are also provided.

### INTRODUCTION

This section provides background information related to the present disclosure which is not necessarily prior art.

The present disclosure pertains to an electrochemical device that includes a plurality of electrochemical cells and an integrated storage region that stores and supplies excess electrolyte liquid to the plurality of electrochemical cells. Methods of increasing a lifetime of an electrochemical device are also provided.

As background, high-energy density, electrochemical cells, such as lithium-ion batteries can be used in a variety of consumer products and vehicles, such as Hybrid Electric Vehicles (HEVs) and Electric Vehicles (EVs). Typical lithium-ion, lithium sulfur, and lithium-lithium symmetrical batteries include a first electrode, a second electrode, an electrolyte material, and a separator. One electrode serves as a positive electrode or cathode and another serves as a negative electrode or anode. A stack of battery cells may be electrically connected to increase overall output.

Conventional rechargeable lithium-ion batteries operate by reversibly passing lithium-ions back and forth between the negative electrode and the positive electrode. A separator and an electrolyte are disposed between the negative and positive electrodes. The electrolyte is suitable for conducting lithium-ions and may be in solid (e.g., solid state diffusion) or liquid form. Lithium-ions move from a cathode (positive electrode) to an anode (negative electrode) during charging of the battery, and in the opposite direction when discharging the battery. However, after operating over thousands of cycles, certain lithium-ion batteries and other batteries that cycle lithium exhibit lower capacity and higher resistance, diminishing the lifetime of the battery. Accordingly, it would be desirable to develop reliable, high-performance electrochemical cells that have superior performance, including higher capacity and diminished resistance, for longer durations.

### SUMMARY

This section provides a general summary of the disclosure, and is not a comprehensive disclosure of its full scope or all of its features.

The present disclosure provides in certain variations an electrochemical device. The electrochemical device may include a stack including at least one electrochemical cell. The at least one electrochemical cell includes a first electrode, a second electrode having an opposite polarity from the first electrode, a porous separator, an electrolyte liquid disposed in the porous separator and optionally disposed in the first electrode, the second electrode, or both the first electrode and the second electrode. The stack includes a first volume of electrolyte liquid. The electrochemical device also includes an integrated storage region having a second volume of electrolyte liquid that is in fluid communication with the at least one electrochemical cell in the stack and is configured to transfer the electrolyte liquid into the at least one electrochemical cell in the stack. The second volume is at least about 3% of the first volume.

In one aspect, the stack defines a lateral edge and the integrated storage region is disposed adjacent to and in contact with the lateral edge. The integrated storage region may include a frame structure and housing. The frame structure includes a polymeric material selected from the group consisting of: polyolefins, fluoropolymers, and combinations thereof.

In one aspect, the at least one electrochemical cell includes a first tab connected to the first electrode and a second tab connected to the second electrode. The first tab and the second tab extend beyond the lateral edge. The integrated storage region defines a first side adjacent to the lateral edge and a second side opposite to the first side. The first tab and the second tab respectively pass from and through the first side to and through the second side so as to protrude from the second side.

In one aspect, the at least one electrochemical cell includes a first tab connected to the first electrode and a second tab connected to the second electrode. The lateral edge is on a side of the electrochemical cell opposite to the first tab and the second tab and the integrated storage region is disposed adjacent to and in contact with the lateral edge.

In one aspect, the stack defines a stack height and a stack width. The integrated storage region defines a first height that is less than or equal to the stack height and a first width that is less than or equal to the stack width.

In one aspect, the integrated storage region has a length from a first side to a second side that is greater than or equal to about 1 mm to less than or equal to about 40 mm.

In one aspect, the first electrode includes a first aperture and the second electrode includes a second aperture. The first and second apertures are aligned so that they define the integrated storage region.

In one aspect, the integrated storage region surrounds at least a portion of an exterior of the stack. The integrated storage region includes an adsorbent material that contains the liquid electrolyte.

In other variations, the present disclosure provides an electrochemical device including a plurality of electrochemical cells. Each of the plurality of electrochemical cells respectively includes a first electrode, a second electrode having an opposite polarity from the first electrode, a porous separator, an electrolyte liquid disposed in the porous separator and optionally disposed in the first electrode, the second electrode, or both the first electrode and the second electrode. The plurality of electrochemical cells includes a first volume of electrolyte liquid. An integrated storage region stores a second volume of electrolyte liquid that is in fluid communication with the plurality of electrochemical cells and is configured to transfer the electrolyte liquid into the plurality of electrochemical cells. The second volume of electrolyte liquid is at least about 3% of the first volume.

In one aspect, the plurality of electrochemical cells defines a lateral edge and the integrated storage region is disposed adjacent to and in contact with the lateral edge.

In one aspect, the plurality of electrochemical cells each respectively includes a first tab connected to the first electrode and a second tab connected to the second electrode. The first tab and the second tab extend beyond the lateral edge and the storage region defines a first side adjacent to the lateral edge and a second side opposite to the first side. The first tab and the second tab respectively pass from and through the first side to and through the second side so as to protrude from the second side.

In one aspect, the plurality of electrochemical cells each respectively includes a first tab connected to the first electrode and a second tab connected to the second electrode. The lateral edge is on a side opposite to the first tab and the second tab and the storage region is disposed adjacent to and in contact with the lateral edge.

In one aspect, the plurality of electrochemical cells commonly defines a stack height and a stack width. The integrated storage region defines a first height that is less than or equal to the stack height and a first width that is less than or equal to the stack width.

In one aspect, each of the first electrode and the second electrode includes an aperture, wherein when the apertures are aligned they together define the integrated storage region.

In one aspect, the plurality of electrochemical cells is joined in a stack configuration.

In one aspect, the plurality of electrochemical cells is in a wound configuration.

In one aspect, the integrated storage region surrounds at least a portion of an exterior of the plurality of electrochemical cells. The integrated storage region includes an adsorbent material that contains the liquid electrolyte.

In yet other variations, the present disclosure provides a method of increasing a lifetime of an electrochemical device including introducing a liquid electrolyte into the electrochemical device that includes a plurality of electrochemical cells and an integrated storage region. The integrated storage region is in fluid communication with the plurality of electrochemical cells. Each respective electrochemical cell includes a first electrode, a second electrode having an opposite polarity from the first electrode, and a porous separator. The plurality of electrochemical cells defines a first volume for receiving liquid electrolyte and the integrated storage region defines a second volume for receiving liquid electrolyte. The second volume is at least about 3% of the first volume. During cycling of the electrochemical device, a lifetime of the electrochemical device is increased by at least 500 deep discharge cycles as compared to a comparative electrochemical device lacking the integrated storage region.

In one aspect, the second volume is greater than or equal to about 3% of the first volume to less than or equal to about 10% of the first volume.

In one aspect, the lifetime of the electrochemical device is increased by at least 2,000 deep discharge cycles.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A shows a lithium-ion electrochemical cell stack having a frame design providing excess electrolyte capacity near a plurality of tabs in accordance with one variation of the present disclosure;

FIG. 1B is a detailed view of a region indicated in FIG. 1A showing a side sectional view of a single electrochemical cell within the lithium-ion electrochemical cell stack;

FIG. 2 shows another lithium-ion electrochemical cell stack having a frame design providing excess electrolyte capacity on a side opposite to a plurality of tabs in accordance with another variation of the present disclosure;

FIG. 3 shows yet another lithium-ion electrochemical cell stack having a central region of the stack of cells defining a void region for excess electrolyte capacity in accordance with another variation of the present disclosure;

FIG. 4 shows a wound lithium-ion electrochemical cell stack having a plurality of apertures that define a central void region for excess electrolyte capacity after winding the respective layers in accordance with another variation of the present disclosure;

FIG. 5 shows another lithium-ion electrochemical cell stack having a stack of distinct cells encapsulated with an adsorbent material that provides excess electrolyte capacity in accordance with another variation of the present disclosure;

FIG. 6 shows the lithium-ion electrochemical cell stack of FIG. 5 during assembly with an external layer of adsorbent material prior to encapsulation of the stack; and

FIG. 7 shows yet another lithium-ion electrochemical cell stack having a cylindrical cell core design that is encapsulated with an adsorbent material that provides excess electrolyte capacity in accordance with another variation of the present disclosure.

### Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology pertains to improved electrochemical cells, especially lithium-ion batteries or lithium-metal batteries, which may be used in vehicle applications. However, the present technology may also be used in other electrochemical devices; especially those that comprise lithium, sodium, or sulfur, such as lithium sulfur batteries, capacitors, lithium-ion capacitors, sodium batteries, so that the discussion of a lithium-ion battery herein is non-limiting.

It has been discovered that for certain lithium-ion electrochemical cell or battery designs, a lifespan of the lithium-ion battery may be diminished due to drying out of the electrolyte after long-term operation. For example, lithium plating has been observed in outer layers, where liquid electrolyte has dried out, causing failure of the electrochemical cell. Electrolyte drying has also been observed to result in increased resistance and diminished discharge capacity, for example, truncating lifespan of comparative electrochemical cell by sometimes several thousand charge/discharge cycles (e.g., shortening lifespan by greater than 2,000 cycles).

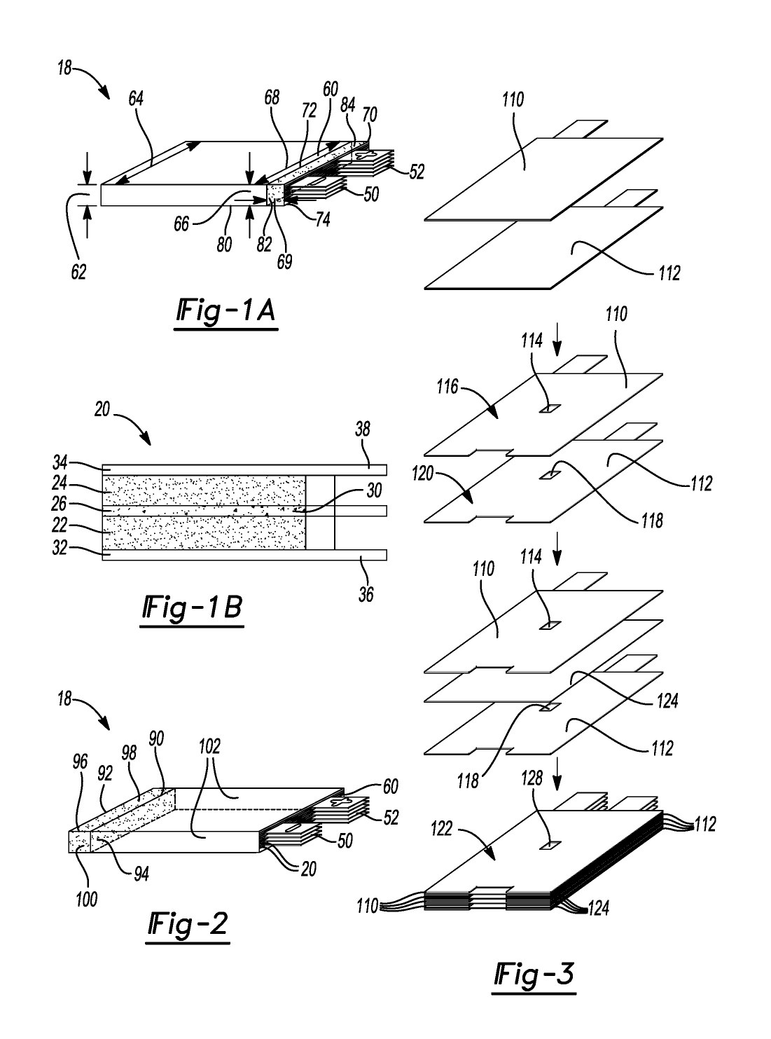

With reference to FIGS. 1A-1B, a lithium-ion electrochemical cell stack 18 is provided that includes a plurality of individual lithium-ion electrochemical cells. FIG. 1B shows a single lithium-ion electrochemical cell or battery 20 from stack 18. The lithium-ion battery 20 includes a negative electrode 22, a positive electrode 24, and a porous separator 26 (e.g., a microporous or nanoporous polymeric separator) disposed between the two electrodes 22, 24. The porous separator 26 includes an electrolyte 30, which may also be present in the negative electrode 22 and positive electrode 24. A negative electrode current collector 32 may be positioned at or near the negative electrode 22 and a positive electrode current collector 34 may be positioned at or near the positive electrode 24. Generally the negative electrode 22 and negative electrode current collector 32 have a somewhat larger area than the positive electrode 24 and positive electrode current collector 34, so that the anode covers the cathode when assembled. The negative electrode current collector 32 and positive electrode current collector 34 are connected to a negative terminal or tab 36 and a positive terminal or tab 38 respectively. The negative tab 36 and positive tab 38 may then be connected to an external circuit where free electrons move to and from. As shown in FIG. 1A, a plurality of negative tabs 50 from the plurality of individual lithium-ion electrochemical cells like 20 may be electrically connected to one another, while a plurality of positive tabs 52 may likewise be electrically connected to one another. An interruptible external circuit is in electrical connection with a load that connects the negative electrode 22 (through its current collector 32 and negative tab 36) and the positive electrode 24 (through its current collector 34 and positive tab 38).

The porous separator 26 operates as both an electrical insulator and a mechanical support, by being sandwiched between the negative electrode 22 and the positive electrode 24 to prevent physical contact and thus, the occurrence of a short circuit. The porous separator 26, in addition to providing a physical barrier between the two electrodes 22, 24, can provide a minimal resistance path for internal passage of lithium ions (and related anions) during cycling of the lithium ions to facilitate functioning of the lithium-ion battery 20.

The lithium-ion battery 20 can generate an electric current during discharge by way of reversible electrochemical reactions that occur when the external circuit is closed (to connect the negative electrode 22 and the positive electrode 34) when the negative electrode 22 contains a relatively greater quantity of lithium. The chemical potential difference between the positive electrode 24 and the negative electrode 22 drives electrons produced by the oxidation of intercalated lithium at the negative electrode 22 through the external circuit toward the positive electrode 24. Lithium ions, which are also produced at the negative electrode, are concurrently transferred through the electrolyte 30 and porous separator 26 towards the positive electrode 24. The electrons flow through the external circuit and the lithium ions migrate across the porous separator 26 in the electrolyte 30 to form intercalated or alloyed lithium at the positive electrode 24. The electric current passing through the external circuit can be harnessed and directed through the load device until the intercalated lithium in the negative electrode 22 is depleted and the capacity of the lithium-ion battery 20 is diminished.

The lithium-ion battery cell 20 (and other cells in the stack 18) can be charged or re-energized at any time by connecting an external power source to the lithium-ion battery 20 to reverse the electrochemical reactions that occur during battery discharge. The connection of an external power source to the lithium-ion battery 20 compels the otherwise non-spontaneous oxidation of intercalated lithium at the positive electrode 24 to produce electrons and lithium ions. The electrons, which flow back towards the negative electrode 22 through the external circuit, and the lithium ions, which are carried by the electrolyte 30 across the separator 26 back towards the negative electrode 22, reunite at the negative electrode 22 and replenish it with lithium for consumption during the next battery discharge cycle. As such, each discharge and charge event is considered to be a cycle, where lithium ions are cycled between the positive electrode 24 and negative electrode 22.

The external power source that may be used to charge the lithium-ion battery 20 may vary depending on the size, construction, and particular end-use of the lithium-ion battery 20. Some notable and exemplary external power sources include, but are not limited to, an AC wall outlet and a motor vehicle alternator. In many lithium-ion battery configurations, each of the negative current collector 32, negative electrode 22, the separator 26, positive electrode 24, and positive current collector 34 are prepared as relatively thin layers (for example, from several microns to a millimeter or less in thickness) and assembled in layers connected in electrical parallel arrangement to form stack 18 to provide a suitable electrical energy and power package.

Furthermore, the lithium-ion electrochemical cell stack 18 can include a variety of other components that while not depicted here are nonetheless known to those of skill in the art. For instance, the stack 18 or each individual battery within stack 18 may include a casing, gaskets, terminal caps, and any other conventional components or materials that may be situated within the battery 20 or stack 18, including between or around the negative electrode 22, the positive electrode 24, and/or the separator 26, by way of non-limiting example. As noted above, the size and shape of the lithium-ion battery 20 may vary depending on the particular application for which it is designed. Battery-powered vehicles and hand-held consumer electronic devices, for example, are two examples where the lithium-ion battery 20 would most likely be designed to different size, capacity, and power-output specifications. When the lithium-ion battery 20 is connected in series or parallel with other similar lithium-ion cells or batteries, a greater voltage output, energy, and power is produced if required by the load device.

Accordingly, the lithium-ion electrochemical cell stack 18 can generate electric current to a load device that can be operatively connected to the external circuit. While the load device may be any number of known electrically-powered devices, a few specific examples of power-consuming load devices include an electric motor for a hybrid vehicle or an all-electric vehicle, a laptop computer, a tablet computer, a cellular phone, mobile device, and cordless power tools or appliances, by way of non-limiting example. The load device may also be a power-generating apparatus that charges the lithium-ion electrochemical cell stack 18 for purposes of storing energy. In certain other variations, the electrochemical cell may be a supercapacitor, such as a lithium-ion based supercapacitor.

With renewed reference to FIGS. 1A-1B, any appropriate electrolyte 30 capable of conducting lithium ions between the negative electrode 22 and the positive electrode 24 may be used in the lithium-ion battery 20. In certain aspects, the electrolyte solution may be a non-aqueous liquid electrolyte solution that includes a lithium salt dissolved in an organic solvent or a mixture of organic solvents. Numerous conventional non-aqueous liquid electrolyte 30 solutions may be employed in the lithium-ion battery 20. A non-limiting list of lithium salts that may be dissolved in an organic solvent to form the non-aqueous liquid electrolyte solution include LiPF₆, LiClO₄, LiAlCl₄, LiI, LiBr, LiSCN, LiBF₄, LiB(C₆H₅)₄, LiB(C₂O₄)₂, LiBF₂(C₂O₄), LiAsF₆, LiCF₃SO₃, LiN(CF₃SO₂)₂, LiN(FSO₂)₂, and combinations thereof. As discussed below, the present technology is particularly suitable for use with an electrolyte that includes LiPF₆ salt. These and other similar lithium salts may be dissolved in a variety of organic solvents, including but not limited to various alkyl carbonates, such as cyclic carbonates (ethylene carbonate (EC), propylene carbonate (PC), butylene carbonate (BC)), linear carbonates (dimethyl carbonate (DMC), diethyl carbonate (DEC), ethylmethylcarbonate (EMC)), aliphatic carboxylic esters (methyl formate, methyl acetate, methyl propionate), γ-lactones (γ-butyrolactone, γ-valerolactone), chain structure ethers (1,2-dimethoxyethane, 1-2-diethoxyethane, ethoxymethoxyethane), cyclic ethers (tetrahydrofuran, 2-methyltetrahydrofuran), and combinations thereof.

The porous separator 26 may include, in certain instances, a microporous polymeric separator including a polyolefin, by way of non-limiting example. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous membranes 26 include CELGARD® 2500 (a monolayer polypropylene separator) and CELGARD® 2320 (a trilayer polypropylene/polyethylene/polypropylene separator) available from Celgard LLC.

When the porous separator 26 is a microporous polymeric separator, it may be a single layer or a multi-layer laminate, which may be fabricated from either a dry or wet process. For example, in one embodiment, a single layer of the polyolefin may form the entire microporous polymer separator 26. In other aspects, the separator 26 may be a fibrous membrane having an abundance of pores extending between the opposing surfaces and may have a thickness of less than a millimeter, for example, and in certain variations, less than about 0.1 mm. As another example, however, multiple discrete layers of similar or dissimilar polyolefins may be assembled to form the microporous polymer separator 26. Furthermore, the porous separator 26 may be mixed with a ceramic material or its surface may be coated in a ceramic material. For example, a ceramic coating may include alumina (Al₂O₃), silicon dioxide (SiO₂), or combinations thereof. Various conventionally available polymers and commercial products for forming the separator 26 are contemplated, as well as the many manufacturing methods that may be employed to produce such a microporous polymer separator 26.

In various aspects, the negative electrode 22 includes an electroactive material as a lithium host material capable of functioning as a negative terminal of a lithium-ion battery. The negative electrode 22 may thus include the electroactive lithium host material and optionally another electrically conductive material, as well as one or more polymeric binder materials to structurally hold the lithium host material together. For example, in one embodiment, the negative electrode 22 may include an active material including graphite, silicon, tin, or other negative electrode particles intermingled with a binder material selected from the group consisting of: polyvinylidene difluoride (PVDF), polytetrafluoroethylene (PTFE), ethylene propylene diene monomer (EPDM) rubber, or carboxymethoxyl cellulose (CMC), a nitrile butadiene rubber (NBR), lithium polyacrylate (LiPAA), sodium polyacrylate (NaPAA), sodium alginate, lithium alginate, and combinations thereof, by way of non-limiting example. Suitable additional electrically conductive materials may include carbon-based material or a conductive polymer. Carbon-based materials may include by way of non-limiting example, particles of KETCHEN™ black, DENKA™ black, acetylene black, carbon black, and the like. Examples of a conductive polymer include polyaniline, polythiophene, polyacetylene, polypyrrole, and the like. In certain aspects, mixtures of conductive materials may be used.

Graphite is often used to form the negative electrode 22 because it exhibits advantageous lithium intercalation and deintercalation characteristics, is relatively non-reactive in the electrochemical cell environment, and can store lithium in quantities that provide a relatively high energy density. Commercial forms of graphite and other graphene materials that may be used to fabricate the negative electrode 22 are available from, by way of non-limiting example, Timcal Graphite and Carbon of Bodio, Switzerland, Lonza Group of Basel, Switzerland, Superior Graphite of Chicago, United States of America, Hitachi Chemicals (e.g., surface modified graphite), BTR China (e.g., graphite material), or Shanshan China (e.g., graphite). Other materials can also be used to form the negative electrode 22, including, for example, lithium-silicon and silicon containing binary and ternary alloys and/or tin-containing alloys, such as Si—Sn, SiSnFe, SiSnAl, SiFeCo, SnO₂, and the like. In certain alternative embodiments, lithium-titanium anode materials are contemplated, such as Li₄₊ₓTi₅O₁₂, where 0≤x≤3, including lithium titanate (Li₄Ti₅O₁₂) (LTO).

The negative electrode current collector 32 and negative tab 36 may be formed from copper, aluminum, or any other appropriate electrically conductive material known to those of skill in the art.

The positive electrode 24 may be formed from a lithium-based active material that can sufficiently undergo lithium intercalation and deintercalation or alloying and dealloying, while functioning as the positive terminal of the lithium-ion battery 20. The positive electrode 24 may include a polymeric binder material to structurally fortify the lithium-based active material. The positive electrode 24 electroactive materials may include one or more transition metals, such as manganese (Mn), nickel (Ni), cobalt (Co), chromium (Cr), iron (Fe), vanadium (V), and combinations thereof. In certain aspects, the positive electrode 24 may include an electroactive material that includes manganese (Mn). Two exemplary common classes of known electroactive materials that can be used to form the positive electrode 24 are lithium transition metal oxides with layered structure and lithium transition metal oxides with spinel phase. For example, in certain embodiments, the positive electrode 24 may include a spinel-type transition metal oxide, like lithium manganese oxide (Li(₁₊ₓ)Mn₍₂₋ₓ₎O₄), where x is typically less than 0.15, including LiMn₂O₄ (LMO) and lithium manganese nickel oxide LiMn_{1.5}Ni_{0.5}O₄(LMNO). In other embodiments, the positive electrode 24 may include layered materials like lithium cobalt oxide (LiCoO₂), lithium nickel oxide (LiNiO₂), a lithium nickel manganese cobalt oxide (Li(NiₓMn_{y}Co_{z})O₂), where 0≤x≤1, 0≤y≤1, 0≤z≤1, and x+y+z=1, including LiMn0.33Ni_{0.33}Co_{0.33}O₂, a lithium nickel cobalt metal oxide (LiNi(_{1-x-y})CoₓM_{y}O₂), where 0<x<1, 0<y<1 and M may be Al, Mn, or the like. Other known lithium-transition metal compounds such as lithium iron phosphate (LiFePO₄) or lithium iron fluorophosphate (Li₂FePO₄F) can also be used. In certain aspects, the positive electrode 24 may include an electroactive material that includes manganese, such lithium manganese oxide (Li₍₁₊ₓ₎Mn₍₂₋ₓ₎O₀₄), a mixed lithium manganese nickel oxide (LiMn₍₂₋ₓ₎NiₓO₄), where 0≤x≤1, and/or a lithium manganese nickel cobalt oxide (e.g., LiMn_{1/3}Ni_{1/3}Co_{1/3}O₂).

Such active materials may be intermingled with an optional electrically conductive material and at least one polymeric binder, for example, by slurry casting active materials with such binders, like polyvinylidene difluoride (PVDF), polytetrafluoroethylene (PTFE), ethylene propylene diene monomer (EPDM) rubber, or carboxymethoxyl cellulose (CMC), a nitrile butadiene rubber (NBR), lithium polyacrylate (LiPAA), sodium polyacrylate (NaPAA), sodium alginate, lithium alginate. Electrically conductive materials may include graphite, carbon-based materials, or a conductive polymer. Carbon-based materials may include by way of non-limiting example particles of KETCHEN™ black, DENKA™ black, acetylene black, carbon black, and the like. Examples of a conductive polymer include polyaniline, polythiophene, polyacetylene, polypyrrole, and the like. In certain aspects, mixtures of conductive materials may be used.

The positive current collector 34 and positive tab 38 may be formed from aluminum or any other appropriate electrically conductive material known to those of skill in the art.

In various aspects, the present disclosure thus provides an electrochemical device comprising a plurality of electrochemical cells. Each respective cell comprises a first electrode and a second electrode having an opposite polarity from the first electrode. Each respective cell also includes a porous separator and an electrolyte liquid disposed in the porous separator. The liquid electrolyte is optionally disposed in the first electrode, the second electrode, or both the first electrode and the second electrode. Together, the plurality of electrochemical cells has a first volume of electrolyte liquid. The electrochemical device also includes an integrated storage region that stores a second volume of electrolyte liquid. By integrated, it is meant that the storage region is contained internally within the electrochemical device housing and thus forms an internal integral component of the electrochemical device. The integrated storage region is in fluid communication with the plurality of electrochemical cells and is configured to transfer the electrolyte liquid into the plurality of electrochemical cells, for example, as electrolyte in the electrochemical cells is depleted. In certain variations, the second volume of electrolyte liquid is at least about 3% of the first volume. In certain variations, the second volume is optionally greater than or equal to about 3% to less than or equal to about 10% of the first volume. In certain variations, the second volume is about 5% of the first volume.

In this manner, electrochemical device designs, like that of lithium-ion batteries, provide an integrated electrolyte reservoir contained in the integrated storage region within the electrochemical cell housing to help minimize or prevent drying out of electrolyte, thus leading to maximal longer battery life.

In certain variations, like those shown in FIGS. 1A and 2, an integrated storage region comprises and is defined by a frame structure, which may also have a housing disposed over the frame to contain the liquid electrolyte. The frame structure is disposed adjacent to and in contact with at least one lateral edge of the plurality of electrochemical cells.

In FIG. 1A, the plurality of electrochemical cells are provided as the lithium-ion electrochemical cell stack 18. The aligned cells or individual batteries 20 are aligned within the stack 18, which defines a first lateral edge 60. The plurality of negative tabs 50 and plurality of positive tabs 52 extend beyond the first lateral edge 60. An integrated storage region 70 defines a first side 72 adjacent to the lateral edge 60 and a second side 74 opposite to the first side 72, wherein the negative tabs 50 and the positive tabs 52 pass through the first side 72 and through the second side 74. The negative and positive tabs 50, 52 thus protrude from the second side 74.

The integrated storage region 70 may be formed a frame structure 80 and a housing 82. The housing 82 may thus form a sealed container on multiple sides that contains liquid electrolyte 84. The integrated storage region 70 is in fluid communication along the first side 72 with the plurality of electrochemical cells 20 of the lithium-ion electrochemical cell stack 18. The integrated storage region 70 is thus configured to transfer the electrolyte liquid 84 into the plurality of electrochemical cells 20 when electrolyte is depleted in the stack 18.

The frame structure 80 may comprise a polymeric material selected from the group consisting of: polyolefins, fluoropolymers, and combinations thereof. In certain variations, the polymeric material is selected from the group consisting of: polytetrafluoroethylene (PTFE) (e.g., TEFLON® PTFE), polypropylene (PP), polyethylene (PE), polyvinylidene difluoride (PVdF) (e.g., KYNAR® PVdF), and combinations thereof. The housing 82 disposed around the frame structure 80 may be formed of the same polymeric material as the frame structure 80. Notably, the frame structure 80 and housing 82 may be integrally formed with one another as a single structure, for example, by molding, and formed of the same material.

The plurality of electrochemical cells 20 in the lithium-ion electrochemical cell stack 18 together commonly defines a stack height 62 and a stack width 64. In a typical pouch or prismatic cell, a non-limiting exemplary height of the stack may be greater than or equal to about 5 mm to less than or equal to about 40 mm, optionally greater than or equal to about 6 mm to less than or equal to about 13 mm. A non-limiting exemplary width may be greater than or equal to about 60 mm to less than or equal to about 300 mm, optionally greater than or equal to about 90 mm to less than or equal to about 200 mm. A non-limiting and exemplary length of a typical prismatic cell may be greater than or equal to about 100 mm to less than or equal to about 600 mm, optionally greater than or equal to about 100 mm to less than or equal to about 300 mm. The integrated storage region 70 defines a first height 66 that is less than or equal to the stack height 62 and a first width 68 that is less than or equal to the stack width 64. In certain variations, a length 69 from the first side 72 to the second side 74 is greater than or equal to about 1 mm to less than or equal to about 40 mm.

It should be noted that the frame structure 80 may be formed within a region of the lithium-ion electrochemical cell stack 18 that in conventional designs was only occupied by negative tabs 50 and positive tabs 52. Thus, the size of the design/footprint of the lithium-ion electrochemical cell stack 18 would not need to be altered from a conventional design in the embodiment of FIGS. 1A-1B.

FIG. 2 shows an alternative variation of similar to that shown in FIGS. 1A-1B. For brevity, the same numbering is used for elements shared with the design in FIGS. 1A-1B. In this design, a second lateral edge 90 is disposed on a side opposite to the first lateral edge 60 of the lithium-ion electrochemical cell stack 18. An integrated storage region 92 defines a first side 94 adjacent to the second lateral edge 90. The integrated storage region 92 may be formed a frame structure 96 and a housing 98. The housing 98 may thus form a sealed container on multiple sides that contains liquid electrolyte 100. The integrated storage region 92 is in fluid communication along the first side 94 with the lithium-ion electrochemical cell stack 18. The integrated storage region 92 is thus configured to transfer the electrolyte liquid 100 into the plurality of electrochemical cells 20 when electrolyte is depleted in the stack 18. Integrated electrolyte storage regions may also be disposed on other lateral sides 102 of the lithium-ion electrochemical cell stack 18 alternatively or in addition to the integrated storage region 92 (or integrated storage region 70 of FIG. 1A). Notably, in the design of FIG. 2, the design/footprint of the lithium-ion electrochemical cell stack 18 would be larger than a conventional stack and may require modifications to the attendant equipment and systems, as recognized by those of skill in the art.

In yet another variation shown in FIG. 3, a first electrode 110 and a second electrode 112 are shown. Notably, the electrode referred to herein may be an electrode assembly, including the electrode active material, current collector, and terminal/tabs. A first opening or aperture 114 has a symmetric shape and is formed in a central region 116 of the first electrode 110. The symmetric shape is shown as a square, but may be round or other shapes. A symmetric shape helps with uniformity of cell pressure and electric field inside the cell. The symmetric shape may be punched or cut into the first electrode 110, for example, by laser cutting. Notably, more than one first aperture 114 may be formed in the first electrode 110 and may be positioned in different areas of the first electrode 110.

The second electrode 112 likewise has a second aperture 118 that is also symmetric shape and of the same shape as the first aperture 114 and may be formed in the same manner. The second aperture 118 is formed in a central region 120 of the second electrode 112. As with the first aperture 114, more than one second aperture 118 may be formed in the second electrode 112 and may be positioned in different areas of the second electrode 112. The first aperture 114 in the first electrode 110 and the second aperture 118 in the second electrode 112 can be formed in the same positions. Thus, the first aperture 114 and second aperture 118 may be aligned when the first and second electrodes 110, 112 are assembled together in a stack 122.

A porous separator 124 may be disposed between the first electrode 110 and the second electrode 112 prior to the alignment process. When a plurality of first electrodes 110, porous separators 124, and second electrodes 112 are aligned and assembled together, an integrated storage region 128 is defined by the respective aligned apertures 114 and 118. When the battery is charged with liquid electrolyte, the integrated storage region 128 serves as a reservoir for excess electrolyte. Further, the integrated storage region 128 is in fluid communication with the plurality of electrochemical cells in the stack and because the electrolyte can flow through the porous separator 124, it can be distributed and transferred throughout the stack.

In certain aspects, an area this is percolated with electrolyte for example, in the integrated storage region 128, is less than or equal to about 20% of total electrode area, optionally greater than or equal to about 0.5% to less than or equal to about 5%. The integrated storage region 128 shown in FIG. 3 is thus formed within a region of the lithium-ion electrochemical cell stack 122, so that the size of the design/footprint of the lithium-ion electrochemical cell stack 122 would not need to be altered from a conventional design.

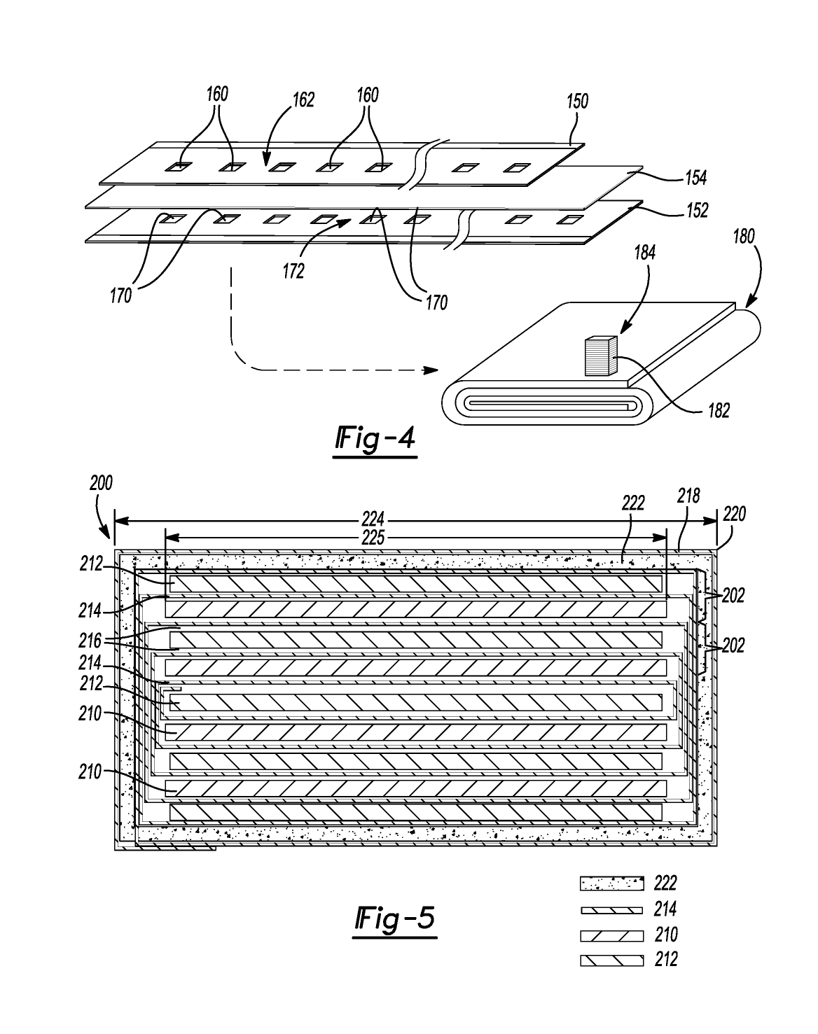

Another variation of an electrochemical device according to the present disclosure is provided in FIG. 4. In this design, a plurality of electrochemical cells is in a wound configuration. A first sheet 150 of a first electrode material is shown. A second sheet 152 of a second electrode material is also shown. Notably, the second sheet 152 has larger dimensions than the first sheet 150 so that it covers the first sheet 150. A third sheet 154 of porous separator material is disposed between the first sheet 150 of first electrode material and the second sheet 152 of the second electrode material. Multiple first apertures 160 are formed in the first sheet 150 of the first electrode material. The first apertures 160 have a symmetric shape like those in FIG. 3 and are generally formed in a central region 162 of the first sheet 150. The symmetric shape of the first apertures 160 is shown as being square, but as previously described, may be other shapes.

Multiple second apertures 170 are formed in the second sheet 152 of the second electrode material. The second apertures 170 share the same symmetric shape as first apertures 160 and are generally formed in a central region 172 of the second sheet 152. The first and second apertures 160 and 170 may be formed by punching or cutting, for example, laser cutting, as described previously above. After disposing the third sheet 154 of the porous separator material between the first sheet 150 and the second sheet 152 are arranged so that each of the multiple first apertures 160 are aligned with the multiple second apertures 170. Then, the assembly of the first sheet 150, second sheet 152, and porous separator 154 are wrapped upon each other to form a wound stack 180 of electrochemical cells. After the winding, an integrated electrolyte storage region 182 is formed in a central region 184 of wound stack 180. When the battery is charged with liquid electrolyte, the integrated electrolyte storage region 182 serves as a reservoir for excess electrolyte. Further, the integrated electrolyte storage region 182 is in fluid communication with the plurality of electrochemical cells in the wound stack 180 and because the electrolyte can flow through the porous separator (third sheet 154), it can be distributed and transferred throughout the stack 180. The integrated electrolyte storage region 182 shown in FIG. 4 is thus formed within a region of the wound stack 180, so that the size of the design/footprint of the stack 180 would not need to be altered from a conventional design.

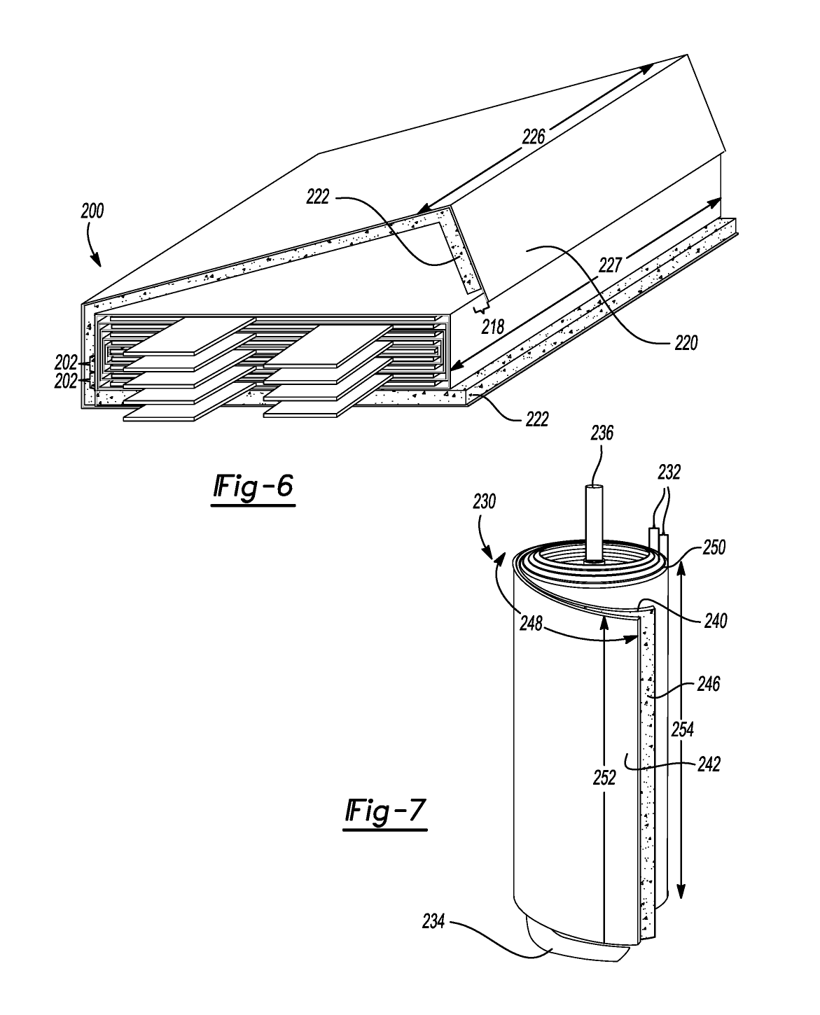

In another variation of the present disclosure shown in FIGS. 5-6, a lithium-ion electrochemical cell stack 200 includes a plurality of electrochemical cells 202 joined together. Each cell 202 includes a negative electrode 210, a positive electrode 212, and a porous separator 214 (e.g., a microporous or nanoporous polymeric separator) disposed between the two electrodes 210 and 212. The porous separator 214 includes an electrolyte, which may also be present in the negative electrode 210 and positive electrode 212. As described above each, negative electrode 210 and positive electrode 212 may be an electrode assembly, including an active material layer, current collector, terminal/tab, and the like.

In this variation, an external housing or cladding 218 encapsulates the plurality of electrochemical cells 202. The cladding 218 includes an optional external housing 220 layer that is impermeable to liquids and outside contaminants. The cladding 218 includes an adsorbent or absorbent material layer 222 that can adsorb/absorb liquid electrolyte. Thus, the absorbent material layer 222 thus serves as the integrated electrolyte storage region of the stack 200. In certain variations, an average porosity of the absorbent material layer 222 may be greater than or equal to about 30% to less than or equal to about 80%. The absorbent material layer 222 is advantageously electrically insulating and stable in the presence of the electrolyte. The absorbent material layer 222 symmetrically covers the plurality of electrochemical cells 202 and in certain variations is co-extensive with the internal surface of the cladding 218.

In certain instances, the absorbent material layer 222 may include a material that is a battery or capacitor porous separator, a cellulose film, a glass fiber paper, a carbon fiber paper, and any combinations thereof. A thickness of the absorbent material layer 222 may be greater than or equal to about 6 μm to less than or equal to about 500 μm. In certain aspects, an adsorbent material layer 222 first dimension 224, such as length, is greater than or equal to a second dimension 225 of the negative electrode 210, such as its length. Further, an adsorbent material layer 222 third dimension 226, such as width, may be greater than or equal to a fourth dimension 227 of the porous separator 214, such as its width.

After wrapping the plurality of electrochemical cells 202, the cladding 218 can be sealed by any conventional manner known in the art. When the battery is charged with liquid electrolyte, the absorbent material layer 222 serves as a reservoir for excess electrolyte. The absorbent material layer 222 is in fluid communication with the plurality of electrochemical cells 202 in the stack 200, so that excess electrolyte can flow into the electrochemical cells and be distributed and transferred throughout the stack 200 as needed.

In FIG. 7, a similar design is shown to that in FIGS. 5 and 6. However, the electrochemical device 230 includes a plurality of electrochemical cells 232 in a wound configuration that form a cylindrical cell core having a first terminal 234 and a second terminal 236 of an opposite polarity. An external housing or cladding 240 encapsulates the plurality of electrochemical cells 232. The cladding 240 includes an external housing layer 242 that is impermeable to liquids and outside contaminants. The cladding 240 also includes an adsorbent or absorbent material layer 246 that can adsorb/absorb liquid electrolyte. Thus, the absorbent material layer 246 serves as the integrated electrolyte storage region of the electrochemical device 230, which is in fluid communication with the plurality of electrochemical cells 232. In this manner, electrolyte can be transferred as required into the electrochemical cells 232 to help prolong the lifetime of the electrochemical device 230. The absorbent material layer 246 may be the same composition with the same properties as described above in the context of absorbent material layer 222 in FIGS. 5 and 6. In certain aspects, an adsorbent material layer 246 first dimension 248, such as length, is greater than or equal to a perimeter 250 of the cylindrical cell core. In a typical metal can cell with a cylindrical shape, a non-limiting exemplary diameter of the cylinder may be greater than or equal to about 18 mm to less than or equal to about 100 mm, optionally greater than or equal to about 18 mm to less than or equal to about 40 mm. A non-limiting and exemplary length of a typical metal can cell may be greater than or equal to about 60 mm to less than or equal to about 600 mm, optionally greater than or equal to about 60 mm to less than or equal to about 200 mm. Further, an adsorbent material layer 246 second dimension 252, such as width, may be greater than or equal to a third dimension 254 of the porous separator 214, such as its width. After wrapping the plurality of electrochemical cells 232, the cladding 240 can be sealed by any conventional manner known in the art.

In various aspects, the present disclosure provides methods of increasing a lifetime of an electrochemical device. The method includes introducing a liquid electrolyte into the electrochemical device that includes a plurality of electrochemical cells and an integrated storage region. The integrated storage region is in fluid communication with the plurality of electrochemical cells and each respective electrochemical cell comprises a first electrode, a second electrode having an opposite polarity from the first electrode, and a porous separator. Any of the previously discussed variations on the electrochemical device incorporating an integrated storage region are contemplated for use in such methods. The plurality of electrochemical cells defines a first volume for receiving liquid electrolyte and the integrated storage region defines a second volume for receiving liquid electrolyte. The second volume is at least about 3% of the first volume and the second volume is greater than or equal to about 3% of the first volume to less than or equal to about 10% of the first volume. During cycling of the electrochemical device, by introducing the excess electrolyte into the integrated storage region, a lifetime of the electrochemical device is increased by at least 500 deep charge/discharge cycles as compared to a comparative electrochemical device having the same plurality of internal cells, but lacking the internal electrolyte storage region. The integrated storage system within the electrochemical device provides additional electrolyte capacity, which helps to minimize or prevent electrolyte dry-out, thus leading to longer battery life.

In certain variations, the electrochemical device incorporating an integrated electrolyte storage region can increase a lifetime of the electrochemical cell by at least about 500 deep discharge cycles, optionally at least about 1,000 deep discharge cycles, optionally at least about 1,500 deep discharge cycles, optionally greater than or equal to about 2,000 deep discharge cycles, and in certain variations, optionally greater than or equal to about 2,500 deep discharge cycles, as compared to a comparative electrochemical device having the plurality of internal cells, but lacking the internal electrolyte storage region.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrochemical device comprising:
a stack comprising at least one electrochemical cell comprising:
a first electrode;
a second electrode having an opposite polarity from the first electrode;
a porous separator;
an electrolyte liquid disposed in the porous separator and optionally disposed in the first electrode, the second electrode, or both the first electrode and the second electrode,
wherein the stack comprises a first volume of electrolyte liquid; and
an integrated storage region having a second volume of electrolyte liquid that is in fluid communication with the at least one electrochemical cell in the stack and is configured to transfer the electrolyte liquid into the at least one electrochemical cell in the stack, wherein the second volume is at least about 3% of the first volume.

2. The electrochemical device of claim 1, wherein the stack defines a lateral edge and the integrated storage region comprises a frame structure and housing and the integrated storage region is disposed adjacent to and in contact with the lateral edge, wherein the frame structure comprises a polymeric material selected from the group consisting of: polyolefins, fluoropolymers, and combinations thereof.

3. The electrochemical device of claim 2, wherein the at least one electrochemical cell comprises a first tab connected to the first electrode and a second tab connected to the second electrode, wherein the first tab and the second tab extend beyond the lateral edge and the integrated storage region defines a first side adjacent to the lateral edge and a second side opposite to the first side, wherein the first tab and the second tab respectively pass from and through the first side to and through the second side so as to protrude from the second side.

4. The electrochemical device of claim 2, wherein the at least one electrochemical cell comprises a first tab connected to the first electrode and a second tab connected to the second electrode, wherein the lateral edge is on a side of the electrochemical cell opposite to the first tab and the second tab and the integrated storage region is disposed adjacent to and in contact with the lateral edge.

5. The electrochemical device of claim 1, wherein the stack defines a stack height and a stack width and the integrated storage region defines a first height that is less than or equal to the stack height and a first width that is less than or equal to the stack width.

6. The electrochemical device of claim 1, wherein the integrated storage region has a length from a first side to a second side that is greater than or equal to about 1 mm to less than or equal to about 40 mm.

7. The electrochemical device of claim 1, wherein the first electrode comprises a first aperture and the second electrode comprises a second aperture, wherein when the first and second apertures are aligned so that they define the integrated storage region.

8. The electrochemical device of claim 1, wherein the integrated storage region surrounds at least a portion of an exterior of the stack, wherein the integrated storage region comprises an adsorbent material that contains the electrolyte liquid.

9. An electrochemical device comprising:
a plurality of electrochemical cells, each respectively comprising:
a first electrode;
a second electrode having an opposite polarity from the first electrode;
a porous separator;
an electrolyte liquid disposed in the porous separator and optionally disposed in the first electrode, the second electrode, or both the first electrode and the second electrode,
wherein the plurality of electrochemical cells comprises a first volume of electrolyte liquid; and
an integrated storage region that stores a second volume of electrolyte liquid that is in fluid communication with the plurality of electrochemical cells and is configured to transfer the electrolyte liquid into the plurality of electrochemical cells, wherein the second volume of electrolyte liquid is at least about 3% of the first volume.

10. The electrochemical device of claim 9, wherein the plurality of electrochemical cells defines a lateral edge and the integrated storage region is disposed adjacent to and in contact with the lateral edge.

11. The electrochemical device of claim 10, wherein the plurality of electrochemical cells each respectively comprises a first tab connected to the first electrode and a second tab connected to the second electrode, wherein the first tab and the second tab extend beyond the lateral edge and the integrated storage region defines a first side adjacent to the lateral edge and a second side opposite to the first side, wherein the first tab and the second tab respectively pass from and through the first side to and through the second side so as to protrude from the second side.

12. The electrochemical device of claim 10, wherein the plurality of electrochemical cells each respectively comprises a first tab connected to the first electrode and a second tab connected to the second electrode, wherein the lateral edge is on a side opposite to the first tab and the second tab and the integrated storage region is disposed adjacent to and in contact with the lateral edge.

13. The electrochemical device of claim 9, wherein the plurality of electrochemical cells commonly define a stack height and a stack width and the integrated storage region defines a first height that is less than or equal to the stack height and a first width that is less than or equal to the stack width.

14. The electrochemical device of claim 9, wherein each of the first electrode and the second electrode comprises an aperture, so that the apertures are aligned to together define the integrated storage region.

15. The electrochemical device of claim 9, wherein the plurality of electrochemical cells is joined in a stack configuration.

16. The electrochemical device of claim 9, wherein the plurality of electrochemical cells is in a wound configuration.

17. The electrochemical device of claim 9, wherein the integrated storage region surrounds at least a portion of an exterior of the plurality of electrochemical cells, wherein the integrated storage region comprises an adsorbent material that contains the electrolyte liquid.

18. A method of increasing a lifetime of an electrochemical device comprising:
introducing a liquid electrolyte into the electrochemical device that comprises a plurality of electrochemical cells and an integrated storage region, wherein the integrated storage region is in fluid communication with the plurality of electrochemical cells and each respective electrochemical cell comprises a first electrode, a second electrode having an opposite polarity from the first electrode, and a porous separator, wherein the plurality of electrochemical cells defines a first volume for receiving liquid electrolyte and the integrated storage region defines a second volume for receiving liquid electrolyte, wherein the second volume is at least about 3% of the first volume, wherein during cycling of the electrochemical device, a lifetime of the electrochemical device is increased by at least 500 deep discharge cycles as compared to a comparative electrochemical device lacking the integrated storage region.

19. The method of claim 18, wherein the second volume is greater than or equal to about 3% of the first volume to less than or equal to about 10% of the first volume.

20. The method of claim 18, wherein the lifetime of the electrochemical device is increased by at least 2,000 deep discharge cycles.
